(19) United States
(12) Patent Application Publication
(10) Pub. No.: US 2007/0163507 A1
(43) Pub. Date: Jul. 19, 2007

(54) PORTABLE PET BOWL

(76) Inventor: Patrick Lynch, Boston, MA (US)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 11/563,976

(22) Filed: Nov. 28, 2006

Related U.S. Application Data
(60) Provisional application No. 60/597,364, filed on Nov. 28, 2005.

(51) Int. Cl. A01K 5/01

(52) U.S. Cl. 119/61.56

(57) ABSTRACT

A portable pet bowl system and methods for using the same are provided. In one exemplary embodiment, the system can includes a collar that is adapted to be worn by a pet, and a support structure that can be stored in the collar and that can be removed to mate to the collar for holding a bag in an open position. The system can also include a bag that is adapted to mate to the collar, and/or a storage container that is also matable to the collar.

### CROSS-REFERENCE TO RELATED APPLICATIONS

The present application claims priority to U.S. Provisional Application No. 60/597,364 filed on Nov. 28, 2005 and entitled “Portable Pet Bowl,” which is hereby incorporated by reference in its entirety.

### BACKGROUND OF THE INVENTION

It is common for pets, such as dogs, to accompany their owners during outdoor activities, such as walking, biking, or jogging. In warm seasons, the pet may become thirsty while accompanying their owner. Depending upon the location, a clean source of drinking water may not be readily available for the pet, and even if a source of water were available (such as a water fountain in a park), the owner may not have a suitable container present to put the drinking water in for the pet. Thus, many owners bring water and a bowl with them for their pet. However, depending on the type of outdoor activity, it is not always practical to carry a container of water and a drinking bowl. In the past, harnesses have been devised to allow animals to carry food and/or beverages. Typically, these devices include saddle bags or other containers that hang over either side of the pet and are supported by straps on the pet's back. However, such harnesses can be cumbersome and awkward to use.

Accordingly, there remains a need for a portable pet bowl that can be worn by the pet, and that is not cumbersome.

### SUMMARY OF THE INVENTION

The present invention generally provides a portable pet bowl system and methods for using the same. In one exemplary embodiment, the portable pet bowl system can include a collar having opposed ends adapted to mate to one another, and a bag having an opening formed therein and adapted to hold a substance. The bag can be configured to be disposed around the collar such that the collar encircles the opening of the bag when the opposed ends of the collar are mated to one another. The system can also include a support structure movable between a collapsed position in which the support structure is disposed within the collar, and an extended position in which the support structure extends from the collar to support the bag in an upright position for receiving a substance. The system can also optionally include a canteen matable to the collar and adapted to hold a plurality of bags therein.

The collar can have a variety of configurations, but in one embodiment the collar can include a storage compartment formed therein for storing the support structure. In an exemplary embodiment, the collar can have a generally circular shape when the opposed ends are mated to one another, and the storage compartment can be formed on an inner surface of the collar when the opposed ends are mated to one another. The storage component can be, for example, at least one pocket formed in the collar. The collar can also include a fastening element for removably fastening an opening extending into the pocket.

The bag can also have a variety of configurations, but in one embodiment the bag can include at least one mating element formed on a sidewall thereof for receiving the collar therethrough. The mating element on the bag can be, for example, a pathway formed in the sidewall of the bag and extending around the opening. The pathway can be configured to slidably receive the collar therethrough. In another embodiment, the mating element on the bag can be a plurality of loop structures coupled to the sidewall of the bag and spaced a distance apart from one another around the opening of the bag. The loop structures can be configured to slidably receive the collar therethrough.

The support structure can also have a variety of configurations, and in one embodiment the support structure can be in the form of at least one leg slidably mated to the collar. In another embodiment, the support structure can be at least one leg pivotally mated to a base member. The collar can include at least one pocket formed therein for slidably receiving the at least one leg on the support structure to mate the support structure to the collar.

In yet another embodiment, a portable pet bowl system is provided and includes a collar having opposed ends adapted to mate to one another, and opposed top and bottom edges extending along a length of the collar. A support structure is coupled to the collar and is movable between a collapsed position in which the support structure is positioned between the opposed top and bottom edges of the collar, and an extended position in which the support structure extends beyond the bottom edge of the collar and is adapted to support a bag disposed around the collar in an open upright position.

In one aspect, the collar can include an elongate member slidably coupled to the support structure, and a cover disposed around the elongate member. The cover can be adapted to receive the support structure therein when the support structure is in the collapsed position. In other embodiments, the system can include a bag defining an opening adapted to hold a substance. The bag can be adapted to be disposed around the collar when the opposed ends of the collar are mated to one another. The system can further include at least one clip removably mated to the collar and adapted to engage the bag.

### BRIEF DESCRIPTION OF THE DRAWINGS

The invention will be more fully understood from the following detailed description taken in conjunction with the accompanying drawings, in which:

FIG. 1A is a perspective view of one exemplary embodiment of a portable pet bowl system shown assembled for storage or wear;

FIG. 1B is a perspective view of the portable pet bowl system of FIG. 1A shown assembled for use as a bowl;

FIG. 2A is a partially transparent side view of a collar portion of the portable pet bowl system of FIGS. 1A and 1B, showing an outer surface of the collar in an unfastened position;

FIG. 2B is a side view of the collar portion of the portable pet bowl system of FIGS. 1A and 1B, showing an inner surface of the collar having a storage component formed thereon and in a closed position;

FIG. 2C is a side view of the collar of FIG. 2B, showing the storage component in an open position;

FIG. 3 is a perspective view of a support structure of the portable pet bowl system of FIGS. 1A and 1B, showing the support structure in an extended upright position;

FIG. 4A is a perspective view of another embodiment of a collar portion and support structure of a portable pet bowl system, showing the collar in the open position and the support structure in a collapsed position;

FIG. 4B is a perspective view of the collar portion and support structure of FIG. 4A, showing the support structure in an extended position for use;

FIG. 5 is a perspective view of one exemplary embodiment of a bag for use with a portable pet bowl system;

FIG. 6 is a perspective view of one exemplary embodiment of a storage container for use with a portable pet bowl system.

### DETAILED DESCRIPTION OF THE INVENTION

The present invention provides a portable pet bowl system and methods for using the same. In general, the portable pet bowl system can include a collar that is adapted to be disposed around and worn on a pet's neck, and a collapsible support structure that can be stored in the collar and that is extendible from the collar to form a bowl-type structure. The system can also optionally include a bag that can be disposed around the collar and that can extend into the support structure for holding a substance, such as food or water. The bag can optionally be stored in a storage container that can mate to the collar to allow the pet to transport the entire system.

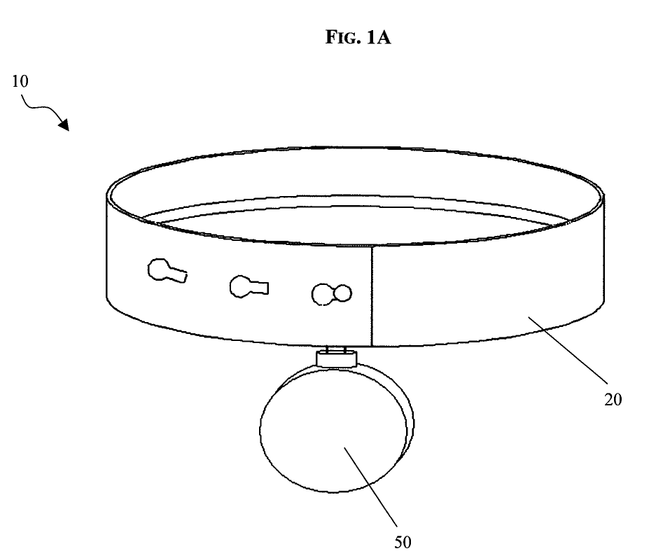

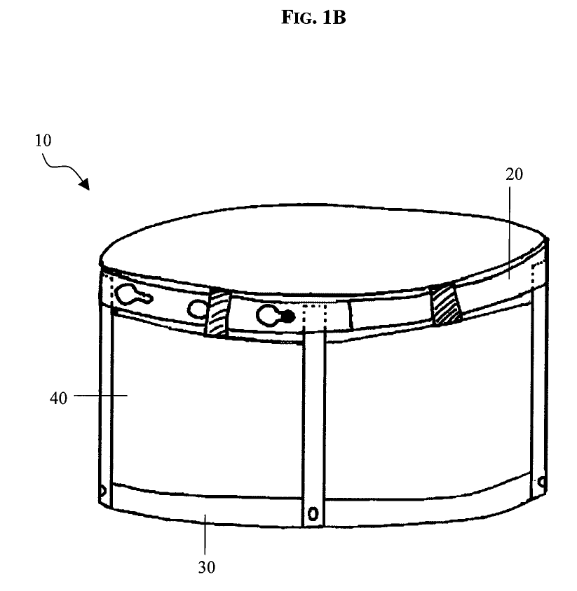

FIGS. 1A-1B illustrate one exemplary embodiment of a portable pet bowl system 10. As shown, the system 10 generally includes a collar 20 that is adapted to be worn by a pet, and a collapsible support structure 30 that can be stored in the collar 20 and that is extendible from the collar 20 when assembled. The system 10 can also include a bag 40 that is adapted to mate to the collar 20, and a storage container 50 that is matable to the collar 20 for storing one or more bags and/or a substance, such as food or water. In use, the bag 40 can be disposed over or mated to the collar 20 to form a bowl, and the support structure 30 can be effective to hold the bag 40 in an open configuration enabling the bag 40 to contain a substance, such as water or food, therein for feeding a pet. A person skilled in the art will appreciate that virtually any bag can be used with the system, including standard waste disposal bags.

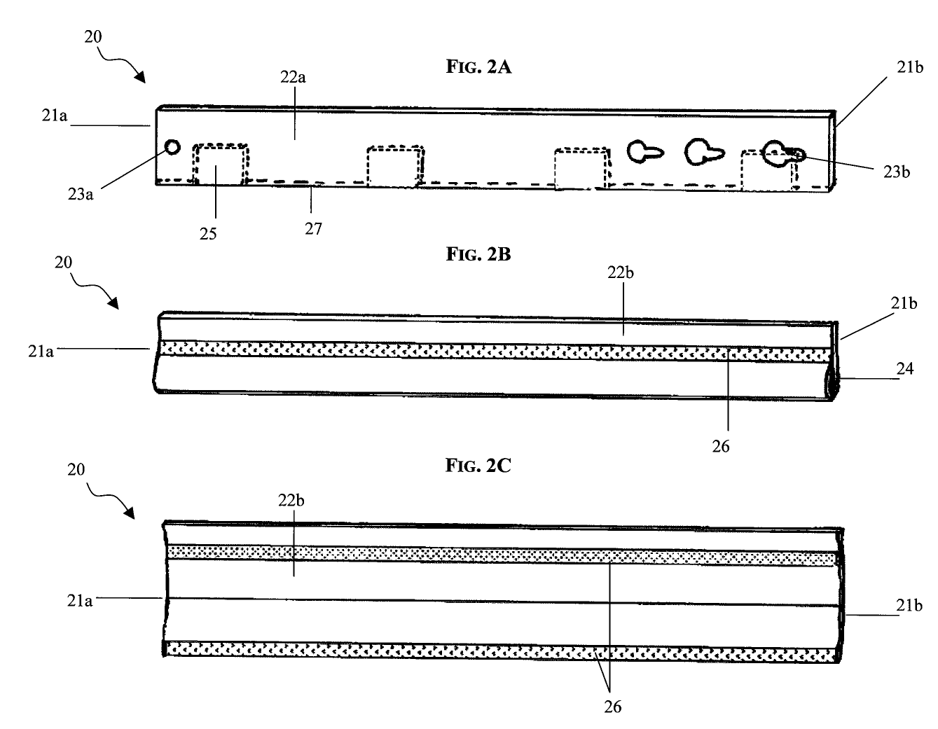

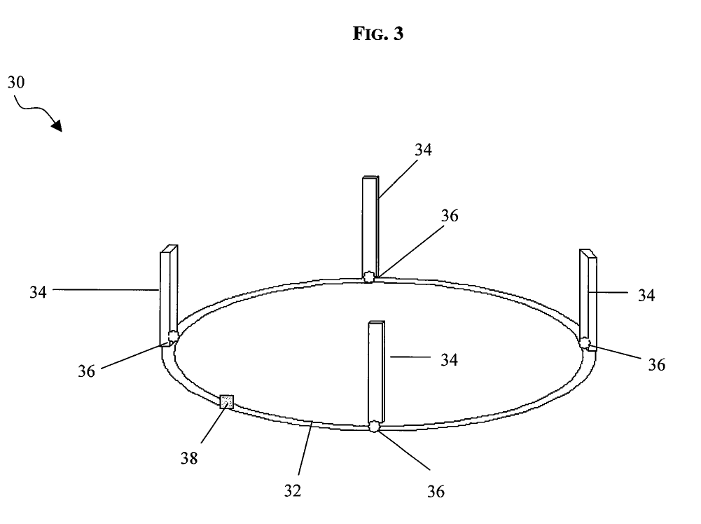

The collar 20 of the portable pet bowl system can have a variety of configurations, shapes, and sizes. In the embodiment shown in FIGS. 1A-1B, the collar 20 has a generally elongate shape with opposed ends 21a, 21b that can mate to one another to form a circular structure. The opposed ends 21a, 21b can be mated using a variety of techniques, but in an exemplary embodiment the collar 20 includes a fastening element formed on each end 21a, 21b and configured to adjustably mate the ends 21a, 21b to one another. The fastening elements are shown in more detail in FIG. 2A, which illustrates an outer sidewall 22a of the collar 20. As shown, the fastening element at one end 21a of the collar 20 is in the form of a pin or key 23a, and the fastening element at the other end 21b of the collar 20 is in the form of a keyhole 23b. The collar 20 is secured by pushing the pin 23a through the keyhole 23b and sliding it into place. To provide a custom fit, the collar 20 can include several keyholes 23b spaced a distance apart from one another along a length of the collar 20. Alternative fastening elements can include a hook and loop fastener, such as Velcro™, a button fastener, a snap-type fastener, a belt fastener, etc. A person skilled in the art will appreciate that a variety of fasteners can be used to facilitate fastening the collar 20.

The collar 20 can also include a storage compartment formed therein for storing the support 30, which will be discussed in more detail below. While the storage component can be formed anywhere on the collar 20, FIGS. 2B-2C illustrate a storage compartment formed on the inner surface 22a of the collar 20. In particular, as shown, the storage component is in the form of a pocket 24 that defines a pathway therein for receiving the support. The pocket 24 can be formed, for example, by a length of material that is attached to the collar 20 and extends along a length thereof between the opposed ends 21a, 21b of the collar 20. While not necessary, an opening extending into the pathway 24 can be secured to the collar 20 using, for example, a hook and loop fastener 26, to hold the support 30 therein. FIG. 2B illustrates the pocket 24 in a closed position for holding the support structure 30, and FIG. 2C illustrates the pocket 24 in an open position whereby the support structure 30 is removed.

As previously stated, the collar 20 can be adapted to mate to the support structure 30 when the support structure 30 is in an extended position to thus form a bowl-type structure. The collar 20 can thus include at least one mating element formed thereon for mating to the support structure 30. While various mating techniques can be used, in the embodiment shown in FIG. 2A, the collar 20 includes multiple slots or openings, i.e., pockets 25, formed between the outer and inner surfaces 22a, 22b thereof along a bottom edge 27 of the collar 20. The pockets 25 are configured to receive legs formed on the support structure 30, as will be discussed in more detail below, and thus the pockets 25 are preferably deep enough to allow the legs to be inserted therein to mate the collar 20 to the support structure 30. The pockets 25 can be formed by using two pieces of material to form the inner and outer surfaces 22a, 22b of the collar. The pieces of material can remain unattached to one another at the desired location of each pocket 25, thereby allowing the legs of the support structure 30 to be inserted therein. Alternatively, the pockets 25 can be formed by attaching pieces of material to the inner or outer surface 22a, 22b of the collar 20 such that the material is fixed to the collar 20 along three sides thereof, leaving the bottom edge unattached for receiving the legs. A person skilled in the art will appreciate that a variety of other techniques can be used to mate the legs of the support structure to the collar 20. The number of openings 25 can also vary depending on the number of legs formed on the support structure 30. In the embodiment shown in FIG. 2A, the collar 20 includes four opening 25 formed therein for receiving four legs formed on the support structure 30.

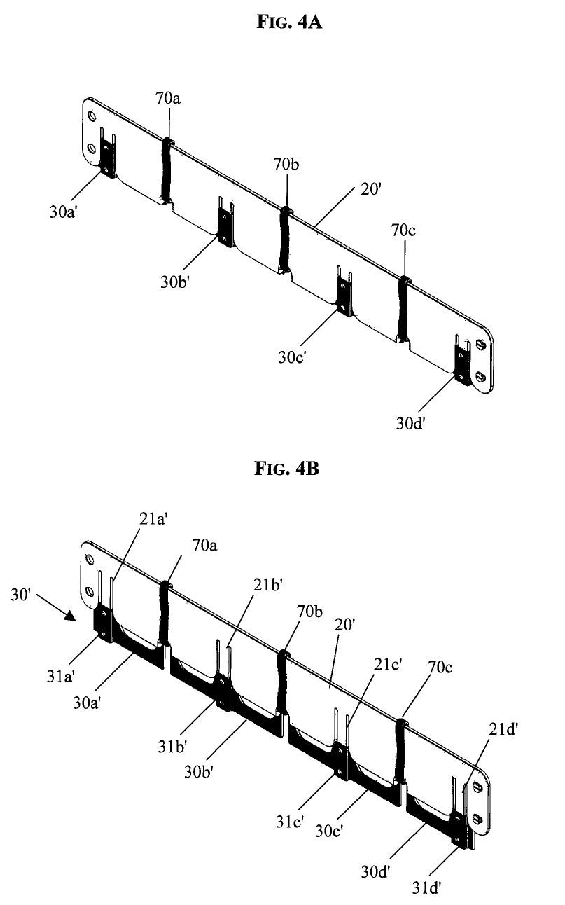

One exemplary support structure 30 is shown in more detail in FIG. 3, and it can have a variety of configurations, shapes, and sizes. As indicated above, the support structure 30 can be configured to mate to the collar such that the collar and support structure can support a bag in an open configuration to allow the bag to hold a substance therein. As shown in FIG. 3, the support structure 30 has a generally elongate shape with opposed ends that mate to one another to form a circular or ring-shaped base 32. A fastener 38 can be used to secure the ends of the base 32 to one another. As further shown, four legs 34 are pivotally coupled, e.g., via hinge joints 36, to the circular base 32. The hinge joints 36 allow the legs 34 to move between a collapsed or folded position in which the legs 34 are positioned adjacent to and extend around the inner surface of the base 32, and an extended or upright position in which the legs 34 extend substantially transverse, e.g., perpendicular, to the base 32. The folded or collapsed position allows the support structure 30 to be stored in the pocket 24 of the collar 20, and the extended upright position allows the support structure 30 to mate to the collar 20 and to support the bag 40 for receiving a substance. In particular, when the legs 34 are in the upright position, each leg 34 can be slid into the corresponding pocket 25 formed in the collar 20, thereby holding the collar 20a distance apart from the base 32 to form a bowl-type configuration. Once mated to the collar 20, the support structure 30 and collar 20 are capable of supporting a bag 40 in an open position to hold a substance therein. A person skilled in the art will appreciate that the support structure 30 can include any number of legs, and it can have a variety of other configurations for supporting a collar 20. The support structure 30 can also be formed from a variety of materials, but in one exemplary embodiment the support structure 30 is formed from a semi-rigid material to allow flexibility for shaping the circular base 32 and rigidity for supporting the collar 20 and bag 40.

FIGS. 4A and 4B illustrate another embodiment of a support structure 30′ that is movable between a collapsed position in which the support structure 30′ is stored adjacent to the collar 20′, and an extended position in which the support structure 30′ extends from the collar 20′ to support a bag in an upright position for receiving a substance. In this embodiment, only an internal portion, i.e., an elongate member, of the collar 20′ is shown, however a cover, such as a fabric material similar to that shown in FIGS. 2A-2C, can be disposed around all or various portions of the collar 20′. The cover can include pockets or other features to allow the support structure 30′ to be stored therein and extended from the collar 20′. As with the previous embodiment, the illustrated support structure 30′ includes four legs 30a′, 30b′, 30c′, 30d′. The support structure 30′ can, however, include any numbers of legs, including a single leg having a generally elongate configuration. Each leg 30a′, 30b′, 30c′, 30d′ can have a variety of shapes and sizes, but as shown each leg 30a′, 30b′, 30c′, 30d′ has a generally elongate rectangular shape, and each leg can be substantially flexible and somewhat planar to facilitate storage of the legs 30a′, 30b′, 30c′, 30d′ adjacent to the collar 20′. The legs 30a′, 30b′, 30c′, 30d′ can be stored within a pocket formed in the cover (not shown) surrounding the collar 20′, as previously explained, or the legs 30a′, 30b′, 30c′, 30d′ can merely be positioned adjacent to an inner or outer surface of the collar 20′ in the collapsed position. FIG. 4A illustrates the legs 30a′, 30b′, 30c′, 30d′ in the stored position and positioned adjacent to inner and outer surfaces of the collar 20′. The legs 30a′, 30b′, 30c′, 30d′ preferably have a shape and size such that the legs 30a′, 30b′, 30c′, 30d′ will not extend beyond the top and bottom edges of the collar 20′ when the legs 30a′, 30b′, 30c′, 30d′ are in the collapsed position. As further shown in FIGS. 4A and 4B, the legs 30a′, 30b′, 30c′, 30d′ can be slidably or otherwise movable coupled to the collar 20′ to allow the legs 30a′, 30b′, 30c′, 30d′ to be extended from the collar 20′. While various mating techniques can be used, in an exemplary embodiment, as shown in FIG. 4B, each leg 30a′, 30b′, 30c′, 30d′ includes a central portion 31a′, 31b′, 31c′, 31d′ that is adapted to slidably mate to corresponding cut-outs or slots 21a′, 21b′, 21c′, 21d′ formed in the collar 20′. The central portion 31a′, 31b′, 31c′, 31d′ can thus be positioned on a first side of the collar 20′, and the remainder of the legs 30a′, 30b′, 30c′, 30d′ can be positioned on an opposed side of the collar 20′. In use, the legs 30a′, 30b′, 30c′, 30d′ can be slidably moved between the collapsed and extended positions. The central portion 31a′, 31b′, 31c′, 31d′ of each leg 30a′, 30b′, 30c′, 30d′ can also include a retaining element configured to mate to the collar 20′ while still allowing slidable movement of the legs 30a′, 30b′, 30c′, 30d′. The retaining element can prevent removal of the legs 30a′, 30b′, 30c′, 30d′ when the legs 30a′, 30b′, 30c′, 30d′ are in the extended position. Various techniques can also be used to maintain the legs 30a′, 30b′, 30c′, 30d′ in the extended position. For example, the central portion 31′, 31b′, 31c′, 31d′ and slots 21a′, 21b′, 21c′, 21d′ can utilize an interference fit, a compression fit, a dovetail connection, or other releasably matable joints. Other mechanical mating techniques can also be used, such as a retractable linch pin, a pin and bore, or other fastening elements.

As further shown in FIGS. 4A and 4B, the collar 20′ can also include one or more clips 70a, 70b, 70c, 70d removably mated thereto for coupling a bag to the collar 20′. While not shown, the clips 70a, 70b, 70c, 70d are preferably disposed over the cover surrounding the collar 20′. Each clip 70a, 70b, 70c, 70d can have a variety of configurations, but in the illustrated embodiment each clip 70a, 70b, 70c, 70d generally includes opposed legs that are movably coupled to one another to allow the clips 70a, 70b, 70c, 70d to slide onto and engage the collar 20′, as well as a bag disposed around the collar 20′, between the legs. Such a configuration is particularly advantageous as it allows virtually any bag to be used with the portable pet bowl system.

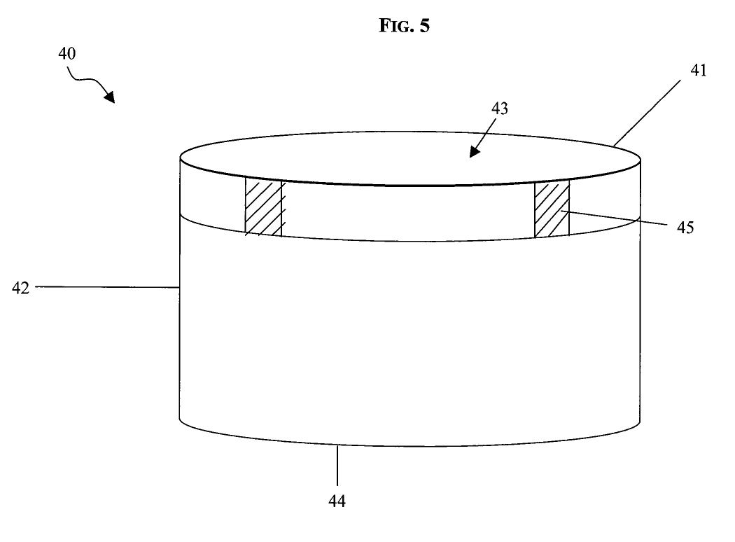

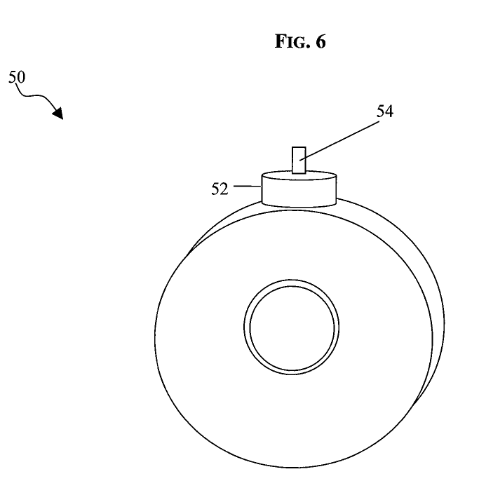

FIG. 5 illustrates another embodiment of a bag 40 that is particularly configured for use with the portable pet bowl system 10 of FIGS. 1A and 1B. In general, the bag 40 is configured to mate to the collar 20 and/or support structure 30. In particular, the bag 40 has a generally circular sidewall 42 that defines an opening 43 formed at one end thereof, and that has a bottom surface 44 attached to an opposite end thereof. While the bag 40 can be folded over the collar 20, in an exemplary embodiment the bag 40 includes at least one mating element formed thereof around a perimeter 41 of the opening 43 for securing the bag 40 to the collar 20. The mating elements can have a variety of configurations, and it can be in the form of a pathway, sleeve, or other element suitable for mating the bag 40 to the collar 20. As shown in FIG. 5, the mating element on the bag 40 is in the form of multiple loop structures 45 that are coupled to the sidewall 42 of the bag 40 and that are spaced a distance apart from one another around the opening 43 of the bag 40. The loop structures are configured to slidably receive the collar 20 therethrough such that the collar 20 forms a loop structure to hold the bag 40 open.

In another exemplary embodiment, the portable pet bowl system 10 can also optionally include a storage container 50, as shown in FIG. 6, for holding multiple bags and/or a substance, such as water or food therein. The container 50 can have virtually any shape and size, but in an exemplary embodiment it is in the form of a hollow housing having one or more compartments formed therein. In the embodiment shown in FIG. 6, the storage container is in the form of a canteen having a lid 52 and a fastening element 54 for mating the storage container to the collar 20. The lid 52 can provide access to the hollow inner compartment, and the fastening element 54 can be attached thereto for mating the container 50 to the collar 20.

Referring back to FIG. 1B, the portable pet bowl system 10 is shown in a configuration assembled for use as a bowl to provide food or water to a pet at home or on the go. To assemble the system 10, the collar 20 is removed from the pet and the support structure 30 is removed from the pocket 24 formed on the inner surface 22b of the collar 20. The bag 40 is then removed from the storage container 50, if provided, and it is mated to the collar 20 by sliding the collar 20 through the loop structures 45 situated around the perimeter 41 of the bag 40 near the opening 43. The opposed ends 21a, 21b of the collar 20 are then mated to one another to form a complete circle. Once the fastening elements 23a and 23b located at each end of the collar 20 are fastened, the bag 40 is held open by the collar 20. The support structure 30 is assembled by mating opposed ends of the base 32 to form a loop, and pivoting the legs 34 from a collapsed position to an upright position. The legs 34 are then slide into the openings 25 formed in the bottom edge 27 of the collar 20, as shown in FIG. 1B. Once the device is fully assembled, water or food can be added to the bowl 60 for the pet to enjoy.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A portable pet bowl system, comprising:
a collar having opposed ends adapted to mate to one another;
a bag having an opening formed therein and adapted to hold a substance, the bag being configured to be disposed around the collar such that the collar encircles the opening of the bag when the opposed ends of the collar are mated to one another; and
a support structure movable between a collapsed position in which the support structure is disposed within the collar, and an extended position in which the support structure extends from the collar to support the bag in an upright position for receiving a substance.

2. The system of claim 1, wherein the collar includes a storage compartment formed therein, and wherein the support structure is storable in the storage compartment.

3. The system of claim 2, wherein the collar has a generally circular shape when the opposed ends are mated to one another, and wherein the storage compartment is formed on an inner surface of the collar when the opposed ends are mated to one another.

4. The system of claim 2, wherein the storage component comprises at least one pocket formed in the collar.

5. The system of claim 4, further comprising a fastening element for removably fastening an opening extending into the pocket.

6. The system of claim 1, further comprising a canteen matable to the collar and adapted to hold a plurality of bags therein.

7. The system of claim 1, wherein the bag includes at least one mating element formed on a sidewall thereof for receiving the collar therethrough.

8. The system of claim 7, wherein the at least one mating element on the bag comprises a pathway formed in the sidewall of the bag and extending around the opening, the pathway being configured to slidably receive the collar therethrough.

9. The system of claim 7, wherein the at least one mating element on the bag comprises a plurality of loop structures coupled to the sidewall of the bag and spaced a distance apart from one another around the opening of the bag, the plurality of loop structures being configured to slidably receive the collar therethrough.

10. The system of claim 1, wherein the support structure comprises at least one leg slidably mated to the collar.

11. The system of claim 10, wherein the support structure comprises at least one leg pivotally mated to a base member.

12. The system of claim 11, wherein the collar includes at least one pocket formed therein for slidably receiving the at least one leg on the support structure to mate the support structure to the collar.

13. The system of claim 1, wherein the opposed ends of the collar are adjustably matable to one another.

14. A portable pet bowl system, comprising:
a collar having opposed ends adapted to mate to one another, and opposed top and bottom edges extending along a length of the collar;
a support structure coupled to the collar and movable between a collapsed position in which the support structure is positioned between the opposed top and bottom edges of the collar, and an extended position in which the support structure extends beyond the bottom edge of the collar and is adapted to support a bag disposed around the collar in an open upright position.

15. The system of claim 14, wherein the collar includes an elongate member slidably coupled to the support structure, and a cover disposed around the elongate member.

16. The system of claim 15, wherein the cover is adapted to receive the support structure therein when the support structure is in the collapsed position.

17. The system of claim 14, further comprising a bag defining an opening adapted to hold a substance, the bag being adapted to be disposed around the collar when the opposed ends of the collar are mated to one another.

18. The system of claim 17, further comprising at least one clip removably mated to the collar and adapted to engage the bag.
